(19) United States
(12) Patent Application Publication
(10) Pub. No.: US 2021/0366006 A1
(43) Pub. Date: Nov. 25, 2021

(54) RANKING OF BUSINESS OBJECT

(71) Applicant: BEIJING SANKUAI ONLINE TECHNOLOGY CO., LTD, Beijing (CN)

(72) Inventors: Chao ZHONG, Beijing (CN); Huaijun LIU, Beijing (CN); Haiwen LIU, Beijing (CN)

(21) Appl. No.: 17/056,985

(22) PCT Filed: Dec. 14, 2018
(86) PCT No.: PCT/CN2018/121078

§ 371 Date: Nov. 19, 2020

(30) Foreign Application Priority Data
Jun. 8, 2018 (CN) 201810589777.4

(51) Int. Cl. G06Q 30/02; G06N 3/08

(52) U.S. Cl. CPC G06Q 30/0282; G06N 3/08

(57) ABSTRACT

A method for ranking a business object is provided. The method includes: obtaining a historical behavior record; extracting at least one of discrete feature information or continuous feature information of at least one business object from the historical behavior record; inputting at least one of discrete feature information or continuous feature information of each business object into a prediction model obtained by pre-training, and predicting a ranking score of each business object; and ranking each business object according to the ranking score of each business object.

### CROSS-REFERENCE TO RELATED APPLICATIONS

This patent application is a United States national stage of an international application No. PCT/CN2018/121078, filed on Dec. 14, 2018 and entitled “RANKING OF BUSINESS OBJECT”, and the international application claims priority to Chinese Patent Application No. 201810589777.4, filed on Jun. 8, 2018 and entitled “METHOD AND APPARATUS FOR RANKING BUSINESS OBJECT.” Both of these applications are incorporated herein by reference in their entirety.

### TECHNICAL FIELD

This application relates to ranking of a business object in the network technology field.

### BACKGROUND

In the field of neural network technologies, a personalized recommendation system can recommend information to a user. In the takeout industry, a personalized recommendation system can, based on a user's historical orders and current search keywords, recommend to the user some products that may be of interest to the user. A personalized recommendation system includes a recall module and a ranking module. The recall module is configured to obtain a candidate product from a platform according to the user's historical behaviors and real-time behaviors. The ranking module is configured to rank the candidate product.

### SUMMARY

This application provides a method and an apparatus for ranking a business object, an electronic device, and a readable storage medium.

According to an aspect of the embodiments of this application, a method for ranking a business object is provided. The method includes: obtaining at least one historical behavior record; extracting at least one of discrete feature information or continuous feature information of at least one business object from the historical behavior record; inputting at least one of discrete feature information or continuous feature information of each business object into at least one prediction model obtained by pre-training, and predicting a ranking score of each business object; and ranking each business object according to the ranking score of each business object.

According to another aspect of the embodiments of this application, an apparatus for ranking a business object is provided. The apparatus includes: a data obtaining module, configured to obtain at least one historical behavior record; a feature information extraction module, configured to extract at least one of discrete feature information or continuous feature information of at least one business object from the historical behavior record; a prediction module, configured to input at least one of discrete feature information or continuous feature information of each business object into at least one prediction model obtained by pre-training, and predict a ranking score of each business object; and a ranking module, configured to rank each business object according to the ranking score of each business object.

According to another aspect of the embodiments of this application, an electronic device is provided, including: at least one processor, at least one memory, and at least one computer program stored in the memory and executable on the processor; when executing the program, the processor implements the method for ranking a business object.

According to another aspect of the embodiments of this application, a readable storage medium is provided. When at least one instruction in the storage medium is executed by at least one processor of an electronic device, the electronic device is enabled to perform the method for ranking a business object.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1 is a flowchart of steps of a method for ranking a business object according to an embodiment of this application;

FIG. 2 is a schematic diagram of a data structure of a long short-term memory network according to an embodiment of this application;

FIG. 3 is a schematic diagram of a data structure of a long short-term memory network according to an embodiment of this application;

FIG. 4 is a schematic structural diagram of a long short-term memory network according to an embodiment of this application;

FIG. 5 is a schematic structural diagram of a neural cell of a long short-term memory network according to an embodiment of this application;

FIG. 6 is a flowchart of steps of a method for ranking a business object according to another embodiment of this application;

FIG. 7 is a schematic diagram of a data structure of a long short-term memory network according to an embodiment of this application;

FIG. 8 is a structural diagram of an apparatus for ranking a business object according to an embodiment of this application; and

FIG. 9 is a structural diagram of an apparatus for ranking a business object according to another embodiment of this application.

### DETAILED DESCRIPTION

The following clearly and completely describes the technical solutions in the embodiments of this application with reference to the accompanying drawings in the embodiments of this application. Apparently, the described embodiments are some embodiments of this application rather than all of the embodiments. All other embodiments obtained by a person of ordinary skill in the art based on the embodiments of this application without creative efforts shall fall within the protection scope of this application.

In an embodiment, recalling a product through a collaborative filtering algorithm includes: first, analyzing historical behaviors of a target user to obtain a favorite product of the target user; and then calculating a user similarity between a candidate user and the target user, and a product similarity between a candidate product and the favorite product of the target user; and finally, recommending, according to the user similarity, a product favored by the candidate user to the target user, or recommending the candidate product to the target user according to the product similarity.

However, the collaborative filtering algorithm has a problem of relatively high time complexity and a problem of data sparsity in calculating the product similarity and the user similarity, the recall effect of the collaborative filtering algorithm based on user behaviors is relatively poor.

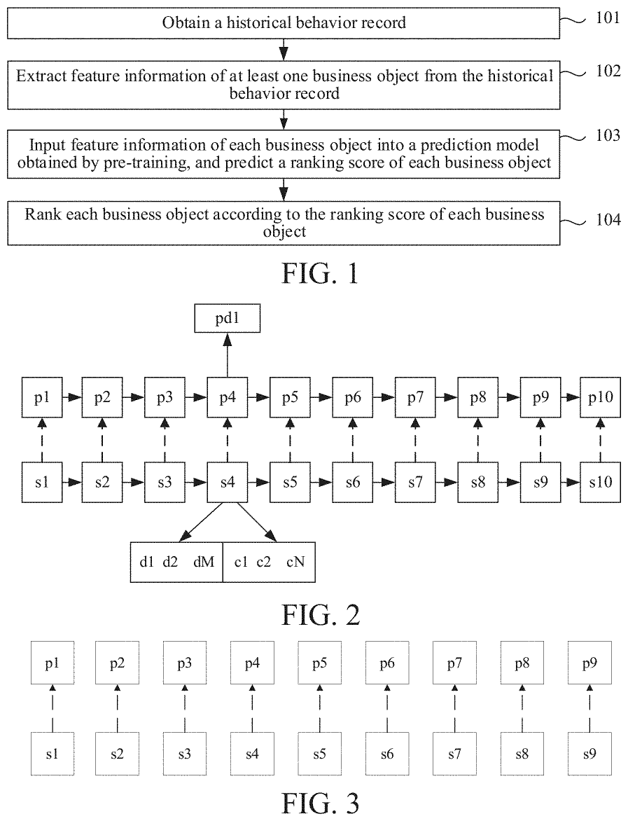

The present disclosure provides a method for ranking a business object, so as to improve the recall effect. FIG. 1 shows a flowchart of a method for ranking a business object according to an embodiment of this application. The method for ranking a business object is applicable to a server and includes steps 101 to 104.

Step 101: Obtain at least one historical behavior record.

This embodiment of this application may be used to determine a ranking score of a business object in the historical behavior record according to the historical behavior record, so as to recommend a business object having a higher ranking score to a user.

Business objects include, but are not limited to, products, advertisements, and merchants.

Historical behavior records include, but are not limited to: a record of browsing a business object in a historical period by the user, an order placing record of the user, and a settlement record of the user. When placing an order in an application (APP), the user may have browsed many business objects. A server corresponding to the application may save the business objects browsed by the user into the database.

In an embodiment, the user's browse record on the business object in the historical period includes click actions that have performed by the user in a current session. For example, in the current session, the user has performed two click actions, and therefore, the historical behavior record may be obtained based on the business objects that the user has browsed before this session and based on the two click actions.

Step 102: Extract feature information of at least one business object from the historical behavior record. The feature information includes at least one of discrete feature information or continuous feature information.

The feature information represents the type of the business object. Business objects that have the same or similar feature information may be classed as one type of business objects. For example, for takeout products, a product sequence browsed by the user is <poi1, poi2, . . . , poiN>, and feature information related to each product includes region information, category information, user identification information, a click-through rate, a conversion rate, a sales volume, an average transaction value, a gross merchandize volume, and the like. The region information, the category information, and the user identification information are discrete feature information, and the click-through rate, the conversion rate, the sales volume, the average transaction value, and the gross merchandize volume are continuous feature information. This embodiment of this application does not limit the quantity of discrete features included in the discrete feature information or the quantity of continuous features included in the continuous feature information.

In an embodiment, the feature information may include only discrete feature information, or may include only continuous feature information.

The extracting feature information of at least one business object from the historical behavior record includes: extracting region information, category information, user identification information, a click-through rate, a conversion rate, a sales volume, an average transaction value, and a gross merchandize volume of the product from the historical behavior record.

FIG. 2 is a schematic diagram of a data structure of a long short-term memory network according to an embodiment of this application. As shown in FIG. 2, s1, s2, . . . , s10 denote input feature information of the business object respectively, and p1, p2, . . . , p10 denote predicted feature information of the business object respectively. In an embodiment, for each business object, the discrete feature information may include M discrete features, and the continuous feature information may include N consecutive features. For example, d1, d2, . . . , dM are M discrete features, and c1, c2, . . . , cN are N continuous features. For each business object, the quantity of discrete features included in the discrete feature information may be different from the quantity of continuous features included in the continuous feature information.

FIG. 3 is a schematic diagram of a data structure of a long short-term memory network according to an embodiment of this application. A length of sequence shown in FIG. 3 is 9. The symbols s1, s2, . . . , s9 denote input feature information of the business object respectively, and p1, p2, . . . , p9 denote predicted feature information of the business object respectively.

Step 103: Input at least one of discrete feature information or continuous feature information of each business object into at least one prediction model obtained by pre-training, and predict a ranking score of each business object.

In this embodiment of this application, the prediction model includes a long short-term memory (LSTM) network in a recurrent neural network (RNN) model.

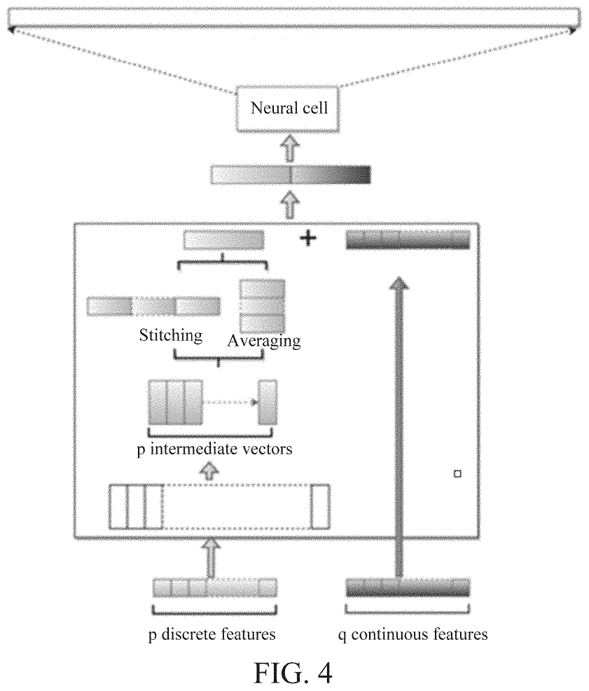

As shown in FIG. 4, an input layer of the LSTM model includes a processing flow in a solid line box. The discrete feature information includes p discrete features, and the continuous feature information includes q continuous features. First, the p discrete features are subjected to an embedding process to generate p embedding vectors. Then, the p embedding vectors are stitched or subjected to an averaging algorithm separately to obtain a total discrete feature vector. Finally, the discrete feature vector and the continuous feature vector are stitched into a total feature vector, which is input to a neural cell of an LSTM network for non-linear operation, and finally a prediction result, such as a ranking score, is output, where q and p are integers greater than 1.

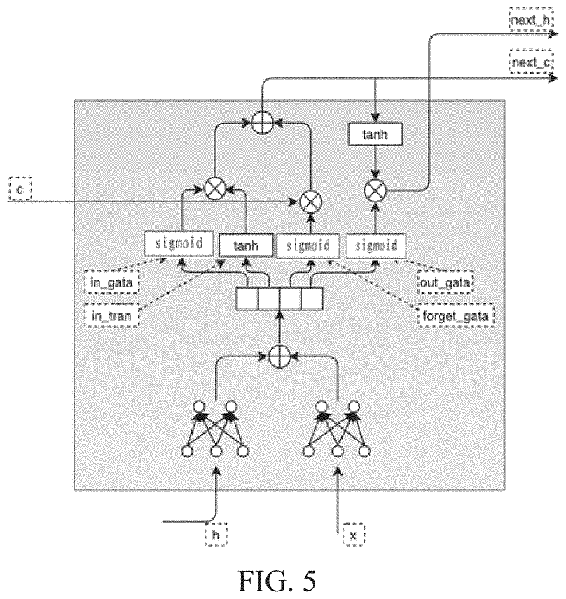

A structure of the neural cell is shown in FIG. 5. In the drawing, h and x denote input information, next_h and next_c denote output values obtained through prediction, c denotes an activation coefficient, in_gata denotes an input gate, out_gata denotes an output gate, forget_gata denotes a forget gate, in_tran denotes a transform gate, and sigmoid and tanh denote activation functions. Understandably, the neural cell may implement a series of non-linear operations through functions sigmoid and tanh. A person skilled in the art are familiar with the neural cell, the sigmoid function, and the tanh function, so that details thereof are omitted here.

It can be understood that in this embodiment of this application, the ranking score of the business object is predicted by using the LSTM model and the feature information of the business object in the input historical behavior record.

Step 104: Rank each business object according to the ranking score of each business object.

In an embodiment, business objects may be ranked in descending or ascending order depending on an actual application scenario.

In addition, a business object ranked ahead may be recommended to the user, or a business object whose ranking score exceeds a preset threshold may be recommended to the user.

The preset threshold is used to determine whether the business object is a target business object, and may be set according to a value range of the ranking score and the actual application scenario. This is not limited in this embodiment of this application.

It can be understood that a recommendation manner may vary with the application scenario. For example, in a takeout scenario, a product or a merchant is displayed on a designated region of a platform. The target business object may also be recommended to the user in other manners. The recommendation manner is not limited in this embodiment of this application.

In conclusion, this embodiment of this application provides a method for ranking a business object. The method includes: obtaining at least one historical behavior record; extracting at least one of discrete feature information or continuous feature information of at least one business object from the historical behavior record; inputting at least one of discrete feature information or continuous feature information of each business object into at least one prediction model obtained by pre-training, and predicting a ranking score of each business object; and rank each business object according to the ranking score of each business object. The ranking score of each business object is predicted by using a pre-trained prediction model, and the business object is ranked to guide subsequent recommendations. In the method for ranking the business object, no problem of data sparsity exists, time complexity is reduced, and the recall effect is improved.

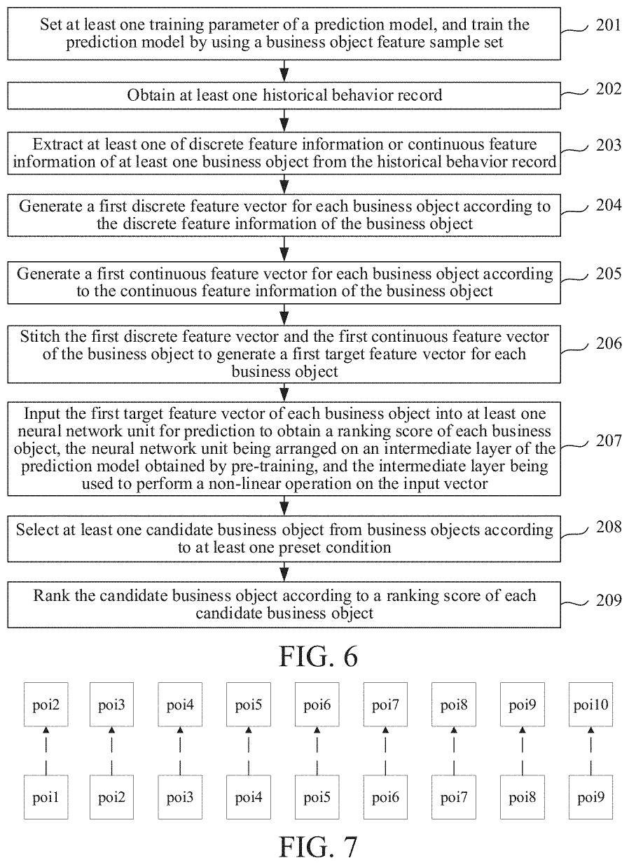

FIG. 6 shows a flowchart of a method for ranking a business object according to another embodiment of this application.

Step 201: Set at least one training parameter of a prediction model, and train the prediction model by using a business object feature sample set.

The training parameter includes a size of a discrete feature dictionary on an input layer, a size of a prediction sequence dictionary on an output layer, an embedding dimension, the quantity of hidden nodes, the quantity of network layers, an operating environment, the quantity of discrete features, the quantity of continuous features, and a combination manner of embedded discrete features, a parameter initialization manner, optimization method selection, a value of a regularized penalty parameter, a discard probability, batch normalization, a sequence length, and the like.

The size of the discrete feature dictionary on the input layer and the size of the prediction sequence dictionary on the output layer, the embedding dimension, the quantity of hidden nodes, and the quantity of network layers are all greater than 0. The operating environment may be set to a central processing unit (CPU) or a graphics processing unit (GPU). The quantity of discrete features is greater than 0. The quantity of continuous features is greater than or equal to 0. The combination manner of embedded discrete features may be set to stitching or averaging. The parameter initialization manner may be set to Gaussian or normal. The optimization method selection may be set to a method of adam, adagrad, or adadelta. The value of the regularized penalty parameter is greater than or equal to 0. The discard probability is greater than or equal to 0. The batch normalization may be set to yes or no.

The sequence length may be set to different lengths depending on a different application scenario. In a takeaway scenario, statistics show that 95% of users browse a sequence length less than or equal to 10 in one session. To cover a majority of training data, the sequence length is set to 9.

It can be understood that all the training parameters are fixed parameters of the LSTM model, and value ranges of the parameters may be set by those skilled in the art according to a requirement, and therefore, details are omitted here.

Each sample in the business object feature sample set includes feature information, and may be collected from massive historical records of users.

In an embodiment, step 201 includes sub-steps 2011 to 2015:

In sub-step 2011: Extract at least one of discrete feature information or continuous feature information of a training-purpose business object from each sample in the business object feature sample set.

Each sample in the business object feature sample set may correspond to one training-purpose business object.

FIG. 7 is a schematic diagram of a data structure of a long short-term memory network according to an embodiment of this application. Using a takeout as an example, the training-purpose business object is a merchant. It is assumed that the feature information of the training-purpose business object includes only discrete feature information, the discrete feature information includes only one discrete feature, such as a merchant identity (ID), and a sequence length browsed by a user in a session is 10, that is, the user has browsed 10 merchants in one session. A data structure constructed in training a prediction model is shown in FIG. 7. FIG. 7 shows that the user has browsed 10 merchants with IDs poi1, poi2, poi3, poi4, poi5, poi6, poi7, poi8, poi9, and poi10 sequentially in one session. After the user browses the poi1 merchant, it is predicted that a next merchant to be browsed by the user is poi2. After the user browses the poi2 merchant, it is predicted that a next merchant to be browsed by the user is poi3. After the user browses the poi3 merchant, it is predicted that a next merchant to be browsed by the user is poi4. After the user browses the poi4 merchant, it is predicted that a next merchant to be browsed by the user is poi5. After the user browses the poi5 merchant, it is predicted that a next merchant to be browsed by the user is poi6. After the user browses the poi6 merchant, it is predicted that a next merchant to be browsed by the user is poi7. After the user browses the poi7 merchant, it is predicted that a next merchant to be browsed by the user is poi8. After the user browses the poi8 merchant, it is predicted that a next merchant to be browsed by the user is poi9. After the user browses the poi9 merchant, it is predicted that a next merchant to be browsed by the user is poi10.

Sub-step 2012: Generate a second discrete feature vector according to the discrete feature information of each training-purpose business object.

In an embodiment, the discrete feature information of the training-purpose business object is mapped into multiple vectors through a function, and then the multiple vectors are combined into one vector.

In an embodiment, sub-step 2012 includes sub-steps 20121 to 20122:

Sub-step 20121: Perform data mapping on the discrete feature information of each training-purpose business object separately to generate a plurality of intermediate discrete feature vectors.

As a common technology in deep learning, embedding-based data mapping maps a piece of feature information into a lower-dimensional vector. The discrete feature information in this embodiment of this application includes multiple discrete features.

Therefore, each discrete feature needs to be mapped into a vector through embedding, and then vectors corresponding to all discrete features are combined into one vector.

The size of the intermediate discrete feature vector may be set according to an embedding dimension of the model parameter.

Sub-step 20122: Perform stitching or an averaging operation on the plurality of intermediate discrete feature vectors to generate a second discrete feature vector.

In an embodiment, multiple intermediate feature vectors are stitched to generate a second discrete feature vector. For example, if the intermediate feature vectors are [a1, a2, a3, a4, a5], [b1, b2, b3, b4, b5], and [c1, c2, c3, c4, c5], the stitched second discrete feature vector is [a1, a2, a3, a4, a5, b1, b2, b3, b4, b5, c1, c2, c3, c4, c5].

In an embodiment, the multiple intermediate feature vectors are averaged to generate a second discrete feature vector. The second feature vector obtained by averaging the above three intermediate feature vectors is [(a1+b1+c1)/3, (a2+b2+c2)/3, (a3+b3+c3)/3, (a4+b4+c4)/3, (a5+b5+c5)/3].

It can be understood that a stitching algorithm or an average algorithm may be selected, which is not limited in this embodiment of this application.

Sub-step 2013: Generate a second continuous feature vector according to the continuous feature information of each training-purpose business object.

In an embodiment, the continuous feature information directly corresponds to a value, and therefore, does not need to be mapped through embedding. Values corresponding to the feature information are directly stitched to form a second continuous feature vector. It can be understood that the quantity of continuous features included in the continuous feature information is the size of the second continuous feature vector. For example, if the continuous features included in the continuous feature information are a monthly average sales volume d and an average price e, the second continuous feature vector is a two-dimensional vector.

Sub-step 2014: Stitch the second discrete feature vector and the second continuous feature vector to generate a second target feature vector.

It can be understood that the size of the second target feature vector is a sum of the size of the second discrete feature vector and the size of the second continuous feature vector. For example, if the second discrete feature vector obtained by stitching in sub-step 2012 is [a1, a2, a3, a4, a5, b1, b2, b3, b4, b5, c1, c2, c3, c4, c5] and the second continuous feature vector obtained in sub-step 2013 is a two-dimensional vector [d, e], then the second target feature vector is [a1, a2, a3, a4, a5, b1, b2, b3, b4, b5, c1, c2, c3, c4, c5, d, e]. If the second discrete feature vector obtained by stitching in sub-step 2012 is [(a1+b1+c1)/3, (a2+b2+c2)/3, (a3+b3+c3)/3, (a4+b4+c4)/3, (a5+b5+c5)/3] and the second continuous feature vector obtained in sub-step 2013 is a two-dimensional vector [d, e], then the second target feature vector is [(a1+b1+c1)/3, (a2+b2+c2)/3, (a3+b3+c3)/3, (a4+b4+c4)/3, (a5+b5+c5)/3, d, e].

Sub-step 2015: Input the second target feature vector into at least one neural network unit for training to obtain the prediction model.

In a possible implementation, the quantity of iterations may be set manually. When the quantity of iterations is reached, the training ends and a prediction model is obtained. Alternatively, the quantity of the iteration is automatically determined based on a loss function, and when a loss value meets a preset condition, the training ends and a matching prediction model is obtained.

Sub-step 2015 includes: using a sigmoid function to activate an output value corresponding to the second target feature vector to obtain an activated output value, and to calculate a loss value using a cross entropy according to the activated output value.

Formula (1) of the sigmoid function is as follows:

$$S ( x ) = \frac{1}{1 - {e}^{- x}} \qquad ( 1 )$$

x denotes an input value, and S(x) denotes the activated output value.

In an embodiment, each element in the second target feature vector is activated through this function to obtain an activated vector.

The cross entropy is used to measure a difference between two probability distributions, for example, a loss value between a true distribution p and a non-true distribution q. When the true distribution p and the non-true distribution q are discrete values, Formula (2) for calculating the loss value H(p, q) is as follows:

$$H ( p , q ) = {\sum }_{i} {p}_{i} \cdot log ( \frac{1}{{q}_{i}} ) \qquad ( 2 )$$

where i denotes an index of activated output values, pᵢ denotes a true probability corresponding to the output value i, and qᵢ denotes a non-true probability corresponding to the output value i.

When the true distribution p and the non-true distribution q are continuous values, Formula (3) for calculating the loss value H(p, q) is as follows:

$$H ( p , q ) = - {\int }_{x} p ( x ) \cdot log ( q ( x ) ) \qquad ( 3 )$$

where x denotes an index of activated output values, p(x) denotes a true probability corresponding to the output value x, and q(x) denotes a non-true probability corresponding to the output value x.

In the process of training the prediction model, the use of a softmax activation function may be avoided, thereby greatly reducing time complexity.

Step 202: Obtain at least one historical behavior record.

For this step, refer to the detailed description of step 101, and details are omitted here.

Step 203: Extract at least one of discrete feature information or continuous feature information of at least one business object from the historical behavior record.

For this step, refer to the detailed description of step 102, and details are omitted here.

Step 204: Generate a first discrete feature vector for each business object according to the discrete feature information of the business object.

For this step, refer to the detailed description of sub-step 2012, and details are omitted here.

In an embodiment, step 204 includes sub-steps 2041 to 2042:

Sub-step 2041: Perform data mapping on the discrete feature information of the business object to generate a plurality of intermediate discrete feature vectors.

For this step, refer to the detailed description of sub-step 20121, and details are omitted here.

Sub-step 2042: Perform stitching or an averaging operation on the plurality of intermediate discrete feature vectors to generate a first discrete feature vector.

For this step, refer to the detailed description of sub-step 20122, and details are omitted here.

Step 205: Generate a first continuous feature vector for each business object according to the continuous feature information of the business object.

For this step, refer to the detailed description of sub-step 2013, and details are omitted here.

Step 206: Stitch the first discrete feature vector and the first continuous feature vector of the business object to generate a first target feature vector for each business object.

For this step, refer to the detailed description of sub-step 2014, and details are omitted here.

Step 207: Input the first target feature vector of each business object into at least one neural network unit for prediction to obtain a ranking score of each business object. The neural network unit is arranged on an intermediate layer of the ranking score prediction model obtained by pre-training. The intermediate layer is used to perform a non-linear operation on the input vector.

In an embodiment, the first target feature vector is input into a neural network unit to perform a non-linear operation on the first target feature vector and calculate a ranking score of each business object.

Step 208: Select at least one candidate business object from business objects according to at least one preset condition.

The candidate business object varies with the type of the business object. For example, for a takeout order, the candidate business object may be a takeout product provided by a merchant near the user. In an embodiment, merchants located at a distance within a preset distance threshold (for example, 3000 meters or 1000 meters) from the user may be used as candidate business objects.

Step 209: Rank the candidate business object according to a ranking score of each candidate business object.

For this step, refer to the detailed description of step 104, and details are omitted here.

In conclusion, the embodiments of this application provide a method for ranking a business object. The method includes: obtaining at least one historical behavior record;

extracting at least one of discrete feature information or continuous feature information of at least one business object from the historical behavior record; inputting at least one of discrete feature information or continuous feature information of each business object into at least one prediction model obtained by pre-training, and predicting a ranking score of each business object; and ranking each business object according to the ranking score of each business object. The ranking score of the business object is predicted by using a pre-trained prediction model, and the business object is ranked to guide subsequent recommendations, thereby reducing time complexity, resolving a problem of data sparsity, and improving a recall effect. In addition, the prediction model may be obtained through pre-training, and a loss value may be calculated with a sigmoid function, thereby reducing calculation complexity.

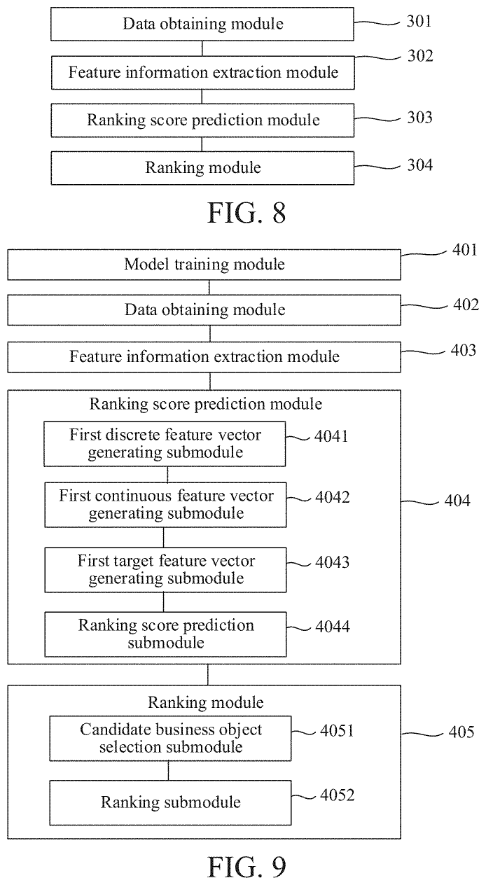

FIG. 8 shows a structural diagram of an apparatus for ranking a business object according to an embodiment of this application, specifically including:

a data obtaining module 301, configured to obtain at least one historical behavior record;

a feature information extraction module 302, configured to extract at least one of discrete feature information or continuous feature information of at least one business object from the historical behavior record;

a prediction module 303, configured to input at least one of discrete feature information or continuous feature information of each business object into at least one prediction model obtained by pre-training, and predict a ranking score of each business object; and

a ranking module 304, configured to rank each business object according to the ranking score of each business object.

In conclusion, this embodiment of this application provides an apparatus for ranking a business object. The ranking score of the business object is predicted by using a pre-trained prediction model, and the business object is ranked to guide recommendations, thereby reducing time complexity, resolving a problem of data sparsity, and improving a recall effect.

FIG. 9 shows a structural diagram of an apparatus for ranking a business object according to another embodiment of this application, specifically including a model training module 401, a data obtaining module 402, a feature information extraction module 403, a prediction module 404, and a ranking module 405.

The model training module 401 is configured to set at least one training parameter of a prediction model, and train the prediction model by using a business object feature sample set.

The data obtaining module 402 is configured to obtain at least one historical behavior record.

The feature information extraction module 403 is configured to extract at least one of discrete feature information r continuous feature information of at least one business object from the historical behavior record.

The prediction module 404 is configured to input at least one of discrete feature information or continuous feature information of each business object into at least one prediction model obtained by pre-training, and predict a ranking score of each business object.

In some embodiments, the prediction module 404 includes: a first discrete feature vector generating submodule 4041, configured to generate a first discrete feature vector for each business object according to the discrete feature information of the business object; a first continuous feature vector generating submodule 4042, configured to generate a first continuous feature vector for each business object according to the continuous feature information of the business object; a first target feature vector generating submodule 4043, configured to stitch the first discrete feature vector and the first continuous feature vector of the business object to generate a first target feature vector for each business object; and a prediction submodule 4044, configured to input the first target feature vector of each business object into at least one neural network unit for prediction to obtain a ranking score of each business object, where the neural network unit is arranged on an intermediate layer of the prediction model obtained by pre-training, and the intermediate layer is used to perform a non-linear operation on the input vector.

The ranking module 405 is configured to rank each business object according to the ranking score of each business object.

In some embodiments, the ranking module 405 includes: a candidate business object selection sub-module 4051, configured to select at least one candidate business object from business objects according to at least one preset condition; and a ranking submodule 4052, configured to rank the candidate business object according to a ranking score of each candidate business object.

In some embodiments, the model training module 401 includes: a feature information extraction submodule, configured to extract at least one of discrete feature information or continuous feature information of a business object from each sample in the business object feature sample set; a second discrete feature vector generating submodule, configured to generate a second discrete feature vector according to the discrete feature information of each sample; a second continuous feature vector generating submodule, configured to generate a second continuous feature vector according to the continuous feature information of each sample; a second target feature vector generating submodule, configured to stitch the second discrete feature vector and the second continuous feature vector to generate a second target feature vector; and a model determining submodule, configured to: input the second target feature vector into at least one neural network unit for training to obtain the prediction model.

In some embodiments, the second discrete feature vector generating submodule includes: a second intermediate discrete feature vector generating unit, configured to perform data mapping on the discrete feature information of each sample separately to generate a plurality of intermediate discrete feature vectors; and a second discrete feature vector generating unit, configured to perform stitching or an averaging operation on the plurality of intermediate discrete feature vectors to generate the second discrete feature vector.

In some embodiments, the model determining submodule includes:

a loss value calculation unit, configured to use a sigmoid function to activate an output value corresponding to the second target feature vector, and use a cross entropy to calculate a loss value.

In some embodiments, the first discrete feature vector generating submodule includes:

a first intermediate discrete feature vector generating unit, configured to perform data mapping on the discrete feature information of the business object to generate a plurality of intermediate discrete feature vectors; and a first discrete feature vector generating unit, configured to perform stitching or an averaging operation on the plurality of intermediate discrete feature vectors to generate the first discrete feature vector.

In conclusion, the embodiments of this application provide an apparatus for ranking a business object. The ranking score of the business object is predicted by using a pre-trained prediction model, and the business object is ranked to guide recommendations, thereby reducing time complexity, resolving a problem of data sparsity, and improving a recall effect. In addition, the prediction model may be obtained through training, and a loss value may be calculated with a sigmoid function, thereby reducing calculation complexity.

An embodiment of this application further provides an electronic device, including: at least one processor, at least one memory, and at least one computer program that is stored in the memory and that can be run on the processor, and when executing the program, the processor implements the foregoing method for ranking a business object.

The processor is configured to perform the following steps:

obtaining at least one historical behavior record; extracting at least one of discrete feature information or continuous feature information of at least one business object from the historical behavior record; inputting at least one of discrete feature information or continuous feature information of each business object into at least one prediction model obtained by pre-training, and predicting a ranking score of each business object; and ranking each business object according to the ranking score of each business object.

In another embodiment, the processor is further configured to perform the following steps:

generating a first discrete feature vector according to the discrete feature information of the business object; generating a first continuous feature vector according to the continuous feature information of the business object; stitching the first discrete feature vector and the first continuous feature vector of the business object to generate a first target feature vector; and inputting the first target feature vector of the business object into at least one neural network unit for prediction to obtain a ranking score of the business object, where the neural network unit is arranged on an intermediate layer of the prediction model obtained by pre-training, and the intermediate layer is used to perform a non-linear operation on the input vector.

In another embodiment, the processor is further configured to perform the following steps:

performing data mapping on the discrete feature information of the business object to generate a plurality of intermediate discrete feature vectors; and performing stitching or an averaging operation on the plurality of intermediate discrete feature vectors to generate the first discrete feature vector.

In another embodiment, the processor is further configured to perform the following steps:

setting at least one training parameter of the prediction model; and training the prediction model through a business object feature sample set.

In another embodiment, the processor is further configured to perform the following steps:

extracting at least one of discrete feature information or continuous feature information of a training-purpose business object from each sample in the business object feature sample set; for the training-purpose business object in each sample, generating a second discrete feature vector according to the discrete feature information of the training-purpose business object; generating a second continuous feature vector according to the continuous feature information of the training-purpose business object; stitching the second discrete feature vector and the second continuous feature vector to generate a second target feature vector of the training-purpose business object; and inputting the second target feature vector of each training-purpose business object into at least one neural network unit for training to obtain the prediction model.

In another embodiment, the processor is further configured to perform the following steps:

performing data mapping on the discrete feature information of the training-purpose business object to generate a plurality of intermediate discrete feature vectors; and performing stitching or an averaging operation on the plurality of intermediate discrete feature vectors to generate the second discrete feature vector of the training-purpose business object.

In another embodiment, the processor is further configured to perform the following steps:

using a sigmoid function to activate an output value corresponding to the second target feature vector to obtain an activated output value; and calculating a loss value with a cross entropy according to the activated output value.

In another embodiment, the processor is further configured to perform the following steps:

selecting at least one candidate business object from business objects according to at least one preset condition; and ranking the candidate business object according to a ranking score of each candidate business object.

An embodiment of this application further provides a readable storage medium. When at least one instruction in the storage medium is executed by a processor of an electronic device, the electronic device is enabled to perform the following steps:

obtaining at least one historical behavior record; extracting at least one of discrete feature information or continuous feature information of at least one business object from the historical behavior record; inputting at least one of discrete feature information or continuous feature information of each business object into at least one prediction model obtained by pre-training, and predicting a ranking score of each business object; and ranking each business object according to the ranking score of each business object.

In another embodiment, when the instruction is run by a processor of a computer, the computer is enabled to perform the following steps:

generating a first discrete feature vector according to the discrete feature information of the business object; generating a first continuous feature vector according to the continuous feature information of the business object; stitching the first discrete feature vector and the first continuous feature vector of the business object to generate a first target feature vector;

and inputting the first target feature vector of the business object into at least one neural network unit for prediction to obtain a ranking score of the business object, where the neural network unit is arranged on an intermediate layer of the prediction model obtained by pre-training, and the intermediate layer is used to perform a non-linear operation on the input vector.

In another embodiment, when the instruction is run by a processor of a computer, the computer is enabled to perform the following steps:

performing data mapping on the discrete feature information of the business object to generate a plurality of intermediate discrete feature vectors; and performing stitching or an averaging operation on the plurality of intermediate discrete feature vectors to generate the first discrete feature vector.

In another embodiment, when the instruction is run by a processor of a computer, the computer is enabled to perform the following steps:

setting at least one training parameter of the prediction model; and training the prediction model through a business object feature sample set.

In another embodiment, when the instruction is run by a processor of a computer, the computer is enabled to perform the following steps:

extracting at least one of discrete feature information or continuous feature information of a training-purpose business object from each sample in the business object feature sample set; for the training-purpose business object in each sample, generating a second discrete feature vector according to the discrete feature information of the training-purpose business object; generating a second continuous feature vector according to the continuous feature information of the training-purpose business object; stitching the second discrete feature vector and the second continuous feature vector to generate a second target feature vector of the training-purpose business object; and inputting the second target feature vector of each training-purpose business object into at least one neural network unit for training to obtain the prediction model.

In another embodiment, when the instruction is run by a processor of a computer, the computer is enabled to perform the following steps:

performing data mapping on the discrete feature information of the training-purpose business object to generate a plurality of intermediate discrete feature vectors; and performing stitching or an averaging operation on the plurality of intermediate discrete feature vectors to generate the second discrete feature vector of the training-purpose business object.

In another embodiment, when the instruction is run by a processor of a computer, the computer is enabled to perform the following steps:

using a sigmoid function to activate an output value corresponding to the second target feature vector to obtain an activated output value; and calculating a loss value with a cross entropy according to the activated output value.

In another embodiment, when the instruction is run by a processor of a computer, the computer is enabled to perform the following steps:

selecting at least one candidate business object from business objects according to at least one preset condition; and ranking the candidate business object according to a ranking score of each candidate business object.

The apparatus embodiments are substantially similar to the method embodiments and therefore are briefly described, and reference may be made to partial descriptions of the method embodiments for the associated part.

Algorithms and displaying provided herein are not inherently related to a particular computer, a virtual system, or another device. Various general purpose systems may also be used together with teachings herein. In accordance with the foregoing descriptions, a structure required for constructing such systems is obvious. In addition, this application is not specific to any particular programming language. It should be understood that the content in this application described herein may be implemented by using various programming languages, and the foregoing description of the particular language is intended to disclose an optimal implementation of this application.

Lots of specific details are described in the specification provided herein. However, it will be appreciated that the embodiments of this application may be implemented in a case without these specific details. In some examples, known methods, structures, and technologies are not disclosed in detail, so as not to mix up understanding on the specification.

Similarly, it should be appreciated that to simplify the present disclosure and help to understand one or more of the application aspects, in the foregoing descriptions of the exemplary embodiments of this application, features of this application are sometimes grouped into a single embodiment or figure, or descriptions thereof. However, the methods in the present disclosure should not be construed as reflecting the following intention: that is, this application claimed to be protected is required to have more features than those clearly set forth in each claim. Or rather, as reflected in the following claims, the application aspects aim to be fewer than all features of a single embodiment disclosed above. Therefore, the claims complying with a specific implementation are definitely combined into the specific implementation, and each claim is used as a single embodiment of this application.

Those skilled in the art may understand that modules in the device in the embodiments may be adaptively changed and disposed in one or more devices different from that in the embodiments. Modules, units, or components in the embodiments may be combined into one module, unit, or component, and moreover, may be divided into a plurality of sub-modules, subunits, or subcomponents. Unless at least one of such features or processes or at least some of such units are mutually exclusive, all features disclosed in this specification (including the accompanying claims, abstract, and drawings) and all processes or units in any disclosed method or device may be combined by using any combination. Unless otherwise definitely stated, each feature disclosed in this specification (including the accompanying claims, abstract, and drawings) may be replaced with a replacement feature providing a same, an equivalent, or a similar objective.

The component embodiments of this application may be implemented by using hardware, may be implemented by using software modules running on one or more processors, or may be implemented by using a combination thereof. A person skilled in the art should understand that some or all functions of some or all components of a device for ranking a business object according to the embodiments of this application may be implemented by using a microprocessor or a digital signal processor (DSP) in practice. This application may further be implemented as a device or an apparatus program configured to perform some or all of the methods described herein. Such program for implementing this application may be stored on a computer-readable medium, or may have one or more signal forms. Such signal may be obtained through downloading from an Internet website, may be provided from a carrier signal, or may be provided in any other forms.

It should be noted that the foregoing embodiments are descriptions of this application instead of a limitation on this application, and a person skilled in the art may design a replacement embodiment without departing from the scope of the accompanying claims. In the claims, any reference symbol located between brackets should not constitute a limitation on the claims. The word “comprise” does not exclude an element or a step not listed in the claims. The word “a” or “one” located previous to an element does not exclude existence of a plurality of such elements. This application may be implemented by hardware including several different elements and an appropriately programmed computer. In the unit claims listing several apparatuses, some of the apparatuses may be specifically presented by using the same hardware. Use of the words such as “first”, “second”, and “third” does not indicate any sequence. These words may be construed as names.

A person skilled in the art may clearly learn that, for simple and clear description, for specific work processes of the foregoing described system, apparatus, and unit, reference may be made to corresponding processes in the foregoing method embodiments, and details are not described herein again.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method for ranking a business object, comprising:
obtaining at least one a historical behavior record;
extracting at least one of discrete feature information or continuous feature information of at least one business object from the historical behavior record;
inputting the at least one of discrete feature information or continuous feature information of each business object into at least one prediction model obtained by pre-training, and predicting a ranking score of each business object; and
ranking each business object according to the ranking score of each business object.

2. The method according to claim 1, wherein the inputting the at least one of discrete feature information or continuous feature information of each business object into at least one prediction model obtained by pre-training, and predicting a ranking score of each business object comprises:
generating a first discrete feature vector according to the discrete feature information of the business object;
generating a first continuous feature vector according to the continuous feature information of the business object;
stitching the first discrete feature vector and the first continuous feature vector of the business object to generate a first target feature vector; and
inputting the first target feature vector of the business object into at least one neural network unit for prediction to obtain a ranking score of the business object, wherein the neural network unit is arranged on an intermediate layer of the prediction model obtained by pre-training, and the intermediate layer is used to perform a non-linear operation on the input vector.

3. The method according to claim 2, wherein the generating a first discrete feature vector according to the discrete feature information of the business object comprises:
performing data mapping on the discrete feature information of the business object to generate a plurality of intermediate discrete feature vectors; and
performing stitching or an averaging operation on the plurality of intermediate discrete feature vcctor vectors to generate the first discrete feature vector.

4. The method according to claim 1, further comprising:
setting at least one training parameter of the prediction model; and
training the prediction model through a business object feature sample set.

5. The method according to claim 4, wherein the training the prediction model through a business object feature sample set comprises:
extracting at least one of discrete feature information or continuous feature information of a training-purpose business object from each sample in the business object feature sample set;
for the training-purpose business object in each sample,
generating a second discrete feature vector according to the discrete feature information of the training-purpose business object;
generating a second continuous feature vector according to the continuous feature information of the training-purpose business object;
stitching the second discrete feature vector and the second continuous feature vector to generate a second target feature vector of the training-purpose business object; and
inputting the second target feature vector of each training-purpose business object into at least one neural network unit for training to obtain the prediction model.

6. The method according to claim 5, wherein the generating a second discrete feature vector according to the discrete feature information of the training-purpose business object comprises:
performing data mapping on the discrete feature information of the training-purpose business object to generate a plurality of intermediate discrete feature vectors; and
performing stitching or an averaging operation on the plurality of intermediate discrete feature vectors to generate the second discrete feature vector of the training-purpose business object.

7. The method according to claim 5, wherein the inputting the second target feature vector of the training-purpose business object into the neural network unit for training comprises:
using a sigmoid function to activate an output value corresponding to the second target feature vector to obtain an activated output value; and
calculating a loss value using a cross entropy according to the activated output value.

8. The method according to claim 1, wherein the ranking each business object according to the ranking score of each business object comprises:
selecting at least one candidate business object from business objects according to at least one preset condition; and
ranking the candidate business object according to a ranking score of each candidate business object.

9. (canceled)

10. An electronic device, comprising:
at least one processor, at least one memory, and at least one computer program stored in the memory and executable on the processor, wherein when executing the computer program, the processor implements the following steps:
obtaining at least one a historical behavior record;
extracting at least one of discrete feature information or continuous feature information of at least one business object from the historical behavior record;
inputting the at least one of discrete feature information or continuous feature information of each business object into at least one prediction model obtained by pre-training, and predicting a ranking score of each business object; and
ranking each business object according to the ranking score of each business object.

11. A readable storage medium, wherein when an instruction in the storage medium is executed by a processor of an electronic device, the electronic device is enabled to perform the method for ranking a business object according to one or more of the method claim 1.

12. The method of claim 1, wherein the business object is a product, advertisement or a merchant.

13. The method of claim 1, wherein the historical behavior record includes one of a record of browsing a business object in a historical period by a user, an order placing record by the user, and a settlement record by the user.

14. The method of claim 1, wherein the feature information includes one of discrete feature information and continuous feature information.

15. The method of claim 14, wherein the discrete feature information comprises one of region information, category information, and a user identification and the continuous feature information comprises one of a click-through rate, a conversion rate, a sales volume, an average transaction value, and a gross merchandize volume.

16. The electronic device of claim 10, wherein the historical behavior records include one of a record of browsing a business object in a historical period by a user, an order placing record by the user, and a settlement record by the user.

17. The electronic device of claim 10, wherein the discrete feature information comprises one of region information, category information, and a user identification and the continuous feature information comprises one of a click-through rate, a conversion rate, a sales volume, an average transaction value, and a gross merchandize volume.
